(19) United States
(12) Patent Application Publication
(10) Pub. No.: US 2025/0338038 A1
(43) Pub. Date: Oct. 30, 2025

(54) PHOTOELECTRIC CONVERSION DEVICE AND PHOTOELECTRIC CONVERSION SYSTEM

(71) Applicant: CANON KABUSHIKI KAISHA, Tokyo (JP)

(72) Inventors: HIDEO KOBAYASHI, Tokyo (JP); TAKANORI SUZUKI, Tokyo (JP)

(21) Appl. No.: 19/183,955

(22) Filed: Apr. 21, 2025

(30) Foreign Application Priority Data
Apr. 25, 2024 (JP) 2024-071604

(51) Int. Cl. H04N 25/773; H04N 23/65; H04N 25/705; H04N 25/709; H04N 25/78; H04N 25/79

(52) U.S. Cl. CPC H04N 25/773; H04N 23/651; H04N 25/705; H04N 25/709; H04N 25/78; H04N 25/79

(57) ABSTRACT

A photoelectric conversion device includes first and second pixel groups, a first signal line, a second signal line, a column circuit including a voltage control unit and a switch circuit. The voltage control unit supplies the predetermined voltage to the second signal line in a first period in which a signal from the first pixel group is output to the first signal line and a signal from the second pixel group is not output, and supplies the predetermined voltage to the first signal line in a second period in which a signal from the second pixel group is output to the second signal line and a signal from the first pixel group is not output. The switch circuit disconnects between the first and second signal lines in the first and second periods and connects the first and second signal lines in a third period between the first and second periods.

### BACKGROUND OF THE INVENTION

### Field of the Invention

The present invention relates to a photoelectric conversion device and a photoelectric conversion system.

### Description of the Related Art

Japanese Patent Application Laid-Open No. 2023-072534 describes a photoelectric conversion device configured to alternately select signal lines used for reading out signals from pixels from two signal output lines arranged in each column of a pixel array unit.

### SUMMARY OF THE INVENTION

According to an embodiment of the present specification, there is provided a photoelectric conversion device including a plurality of pixels including a first pixel group and a second pixel group and arranged to form a column, a plurality of signal lines including a first signal line connected to the first pixel group and a second signal line connected to the second pixel group, and a column circuit connected to the plurality of signal lines and including a voltage control unit configured to control supply of a predetermined voltage to each of the plurality of signal lines and a switch circuit configured to control electrical connection and separation between the plurality of signal lines, wherein the voltage control unit is configured to supply the predetermined voltage to the second signal line in a first period in which a signal from the first pixel group is output to the first signal line and a signal from the second pixel group is not output to the second signal line and supply the predetermined voltage to the first signal line in a second period in which a signal from the second pixel group is output to the second signal line and a signal from the first pixel group is not output to the first signal line, and wherein the switch circuit is configured to disconnect between the first signal line and the second signal line in the first period and the second period and connect the first signal line and the second signal line in a third period between the first period and the second period.

According to another disclosure of the present specification, there is provided a method of driving a photoelectric conversion device including a plurality of pixels including a first pixel group and a second pixel group and arranged to form a column, a first signal line connected to the first pixel group, and a second signal line connected to the second pixel group, the method including electrically separating the first signal line and the second signal line and supplying a predetermined voltage to the second signal line in a first period in which a signal from the first pixel group is output to the first signal line and a signal from the second pixel group is not output to the second signal line, electrically separating the first signal line and the second signal line and supplying a predetermined voltage to the first signal line in a second period in which a signal from the second pixel group is output to the second signal line and a signal from the first pixel group is not output to the first signal line, and electrically connecting the first signal line and the second signal line in a third period between the first period and the second period.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a photoelectric conversion device according to a first embodiment.

FIG. 2 is a circuit diagram illustrating a configuration example of a pixel in the photoelectric conversion device according to the first embodiment.

FIG. 3 is a circuit diagram illustrating a configuration example of a column circuit in the photoelectric conversion device according to the first embodiment.

FIG. 4A and FIG. 4B are schematic diagrams illustrating a configuration example of the photoelectric conversion device according to the first embodiment.

FIG. 5 and FIG. 6 are timing charts illustrating a method of driving the photoelectric conversion device according to the first embodiment.

FIG. 7 is a schematic diagram illustrating a configuration example of a photoelectric conversion device according to a second embodiment.

FIG. 8 is a schematic diagram illustrating a configuration example of a photoelectric conversion device according to a third embodiment.

FIG. 9A and FIG. 9B are schematic diagrams illustrating a configuration example of a photoelectric conversion device according to a fourth embodiment.

FIG. 10 is a timing chart illustrating a method of driving the photoelectric conversion device according to the fourth embodiment.

FIG. 11 is a block diagram illustrating a schematic configuration of a photoelectric conversion system according to a fifth embodiment.

FIG. 12A is a diagram illustrating a configuration example of a photoelectric conversion system according to a sixth embodiment.

FIG. 12B is a diagram illustrating a configuration example of a movable object according to the sixth embodiment.

FIG. 13 is a block diagram illustrating a schematic configuration of an equipment according to a seventh embodiment.

### DESCRIPTION OF THE EMBODIMENTS

In the technique described in Japanese Patent Application Laid-Open No. 2023-072534, it cannot be said that the readout speed of the signals from the pixels is not necessarily sufficient, and it is desired to improve the readout speed.

The following disclosure relates to a technique for improving the readout speed of a signal from a pixel in a photoelectric conversion device in which a plurality of signal output lines is arranged in each column of a pixel array unit.

Preferred embodiments of the present invention will now be described in detail in accordance with the accompanying drawings. In each of the embodiments described below, as an example of the photoelectric conversion device, a device used for imaging will be mainly described. However, each embodiment is not limited to a device for this imaging application and may be applied to other examples included in the photoelectric conversion devices. For example, there are a distance measuring device (device for focus detection or distance measurement using time-of-flight (TOF), and the like), a photometric device (device for measuring the amount of incident light, etc.), and the like.

The conductivity type of each of the transistors described in the embodiments described below is merely an example and is not limited to the conductivity type described in the embodiments. The conductivity type may be appropriately changed with respect to the conductivity type described in the embodiments, and the potentials of the gate, the source, and the drain of the transistor may be appropriately changed in accordance with the change.

For example, in the case of a transistor operating as a switch, low-level and high-level of the potential supplied to the gate may be reversed with respect to the description in the embodiments as the conductivity type is changed. The conductivity type of the semiconductor region described in the embodiments described below is merely an example and is not limited to the conductivity type described in the embodiments. The conductivity type may be appropriately changed with respect to the conductivity type described in the embodiments, and the potential of the semiconductor region is appropriately changed in accordance with the change.

In the following embodiments, connection between elements of a circuit may be described. In this case, even when another element is interposed between the elements of interest, the elements of interest are treated as being connected to each other unless otherwise specified. For example, it is assumed that an element A is connected to one node of a capacitor C having a plurality of nodes, and an element B is connected to the other node. Even in such a case, the element A and the element B are regarded as being connected to each other unless otherwise specified.

### First Embodiment

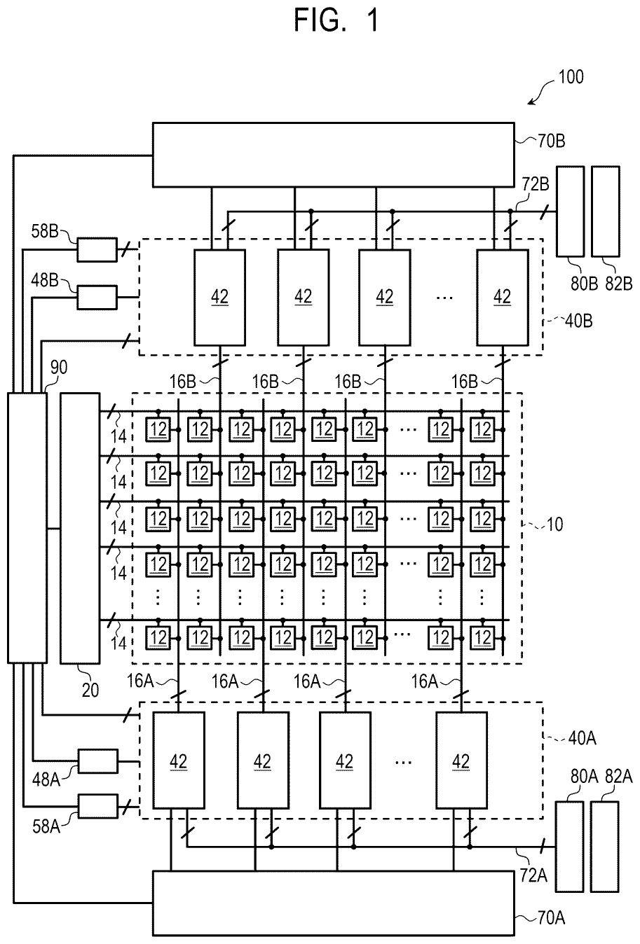

A photoelectric conversion device and a method of driving the same according to a first embodiment of the present invention will be described with reference to FIG. 1 to FIG. 6.

FIG. 1 is a block diagram illustrating a schematic configuration of a photoelectric conversion device according to the present embodiment. As illustrated in FIG. 1, the photoelectric conversion device 100 according to the present embodiment includes a pixel array unit 10, a vertical scanning circuit 20, readout circuits 40A and 40B, reference signal output circuits 48A and 48B, and counter circuits 58A and 58B. The photoelectric conversion device 100 further includes horizontal scanning circuits 70A and 70B, processing circuits 80A and 80B, output circuits 82A and 82B, and a control circuit 90.

The pixel array unit 10 is provided with a plurality of pixels 12 arranged in a matrix over a plurality of rows and a plurality of columns. Each pixel 12 includes a photoelectric conversion unit including a photoelectric conversion element such as a photodiode and outputs a pixel signal according to the amount of incident light. The number of rows and the number of columns of the pixel array arranged in the pixel array unit 10 are not particularly limited. In addition to effective pixels that output pixel signals according to the amount of incident light, the pixel array unit 10 may include optical black pixels in which photoelectric conversion units are shielded from light, dummy pixels that do not output signals, and the like. A specific configuration of the pixel 12 will be described later.

In each row of the pixel array unit 10, a control line 14 is arranged so as to extend in a first direction (lateral direction in FIG. 1). Each of the control lines 14 is connected to the pixels 12 arranged in the first direction on the corresponding row and forms a signal line common to these pixels 12. Each of the control lines 14 may include a plurality of signal lines. The first direction in which the control lines 14 extend may be referred to as a row direction or a horizontal direction. The control lines 14 are connected to the vertical scanning circuit 20.

In each column of the pixel array unit 10, a signal output line 16A or a signal output line 16B is arranged so as to extend in a second direction (vertical direction in FIG. 1) intersecting the first direction. The signal output lines 16A and 16B are alternately arranged in each column. For example, the signal output lines 16A are arranged in odd-numbered columns, and the signal output lines 16B are arranged in even-numbered columns. The signal output lines 16A are connected to the readout circuit 40A. The signal output lines 16B are connected to the readout circuit 40B. The signal output lines 16A and 16B are not necessarily arranged in different columns and may be arranged in the same column.

Each of the signal output lines 16 (the signal line 16A or 16B) arranged in each column includes a plurality of signal lines. The pixels 12 arranged in each column are connected to any of the plurality of signal lines arranged in the corresponding column. In the present embodiment, each of the signal output lines 16A and 16B includes two signal lines (signal lines 161 and 162 described later). In this case, the plurality of pixels 12 arranged in each column includes a first pixel group connected to the signal line 161 and a second pixel group connected to the signal line 162.

The vertical scanning circuit 20 has a function of generating a control signal for driving the pixels 12 in response to a control signal from the control circuit 90 and outputting the generated control signal to the pixel array unit 10. A logic circuit such as a shift register or an address decoder may be used as the vertical scanning circuit 20. The vertical scanning circuit 20 sequentially outputs the control signals to the control lines 14 of each row and performs an operation of sequentially driving the pixels 12 of the pixel array unit 10 in units of rows, that is, so-called vertical scanning. The signals read out from the pixels 12 in units of rows are input to the readout circuit 40A or the readout circuit 40B via the signal output line 16A or the signal output line 16B arranged in each column of the pixel array unit 10.

The readout circuit 40A includes a plurality of column circuits 42 corresponding to the number of columns in which the signal output lines 16A are arranged. Each of the column circuits 42 of the readout circuit 40A is connected to the signal output line 16A of the corresponding column. Similarly, the readout circuit 40B includes a plurality of column circuits 42 corresponding to the number of columns in which the signal output lines 16B are arranged. Each of the column circuits 42 of the readout circuit 40B is connected to the signal output line 16B of the corresponding column. Each of the column circuits 42 is a signal processing circuit that performs predetermined processing on the pixel signals read out from the pixels 12 in the corresponding columns. Examples of the processing performed by the column circuit 42 may include signal processing such as amplification processing and analog-to-digital conversion (AD conversion) processing. Each of the column circuits 42 includes a signal holding circuit (memory) for holding the processed pixel signal.

The reference signal output circuit 48A is connected to the readout circuit 40A. The reference signal output circuit 48A has a function of outputting a reference signal used for AD conversion to the readout circuit 40A in response to a control signal from the control circuit 90. Similarly, the reference signal output circuit 48B is connected to the readout circuit 40B. The reference signal output circuit 48B has a function of outputting a reference signal used for AD conversion to the readout circuit 40B in response to a control signal from the control circuit 90. The reference signal output circuits 48A and 48B may be configured to generate a reference signal and output the reference signal or may be configured to buffer and output a reference signal generated outside the photoelectric conversion device.

The reference signal used for AD conversion may have a predetermined amplitude according to the range of the pixel signal and may be a signal whose signal level changes with time. Although the reference signal is not particularly limited, for example, a ramp signal in which the signal level monotonically increases or monotonically decreases with time may be applied. Note that the change in the signal level does not necessarily have to be continuous and may be stepwise. In addition, the change in the signal level does not necessarily need to be linear with respect to time and may be curved with respect to time (for example, a sine wave or a cosine wave).

The counter circuit 58A is connected to the readout circuit 40A. The counter circuit 58A has a function of performing a count operation in accordance with a control signal from the control circuit 90 and outputting a count signal indicating the count value to the readout circuit 40A. The counter circuit 58A starts the count operation in synchronization with a timing at which a change in the signal level of the reference signal supplied from the reference signal output circuit 48A starts. Similarly, the counter circuit 58B is connected to the readout circuit 40B. The counter circuit 58B has a function of performing a count operation in accordance with a control signal from the control circuit 90 and outputting a count signal indicating the count value to the readout circuit 40B. The counter circuit 58B starts the count operation in synchronization with a timing at which a change in the signal level of the reference signal supplied from the reference signal output circuit 48B starts. Each of the column circuits 42 may have the functions of the counter circuit 58A or 58B.

The horizontal scanning circuit 70A has a function of generating a control signal for reading out a pixel signal from the column circuit 42 of the readout circuit 40A in response to a control signal from the control circuit 90 and outputting the generated control signal to the readout circuit 40A. The horizontal scanning circuit 70A performs an operation of sequentially scanning the column circuits 42 of the readout circuit 40A and sequentially outputting the pixel signals held therein to the processing circuit 80A via the horizontal output line 72A, that is, a so-called horizontal scanning. Similarly, the horizontal scanning circuit 70B has a function of generating a control signal for reading out a pixel signal from the column circuit 42 of the readout circuit 40B in response to a control signal from the control circuit 90 and outputting the generated control signal to the readout circuit 40B. The horizontal scanning circuit 70B performs the same horizontal scanning as that of the horizontal scanning circuit 70A on the column circuit 42 of the readout circuit 40B. A logic circuit such as a shift register or an address decoder may be used for the horizontal scanning circuits 70A and 70B.

The processing circuit 80A may be formed of a buffer amplifier, a differential amplifier, and the like, and has a function of performing predetermined signal processing on the pixel signal of a column selected by the horizontal scanning circuit 70A and outputting the processed pixel data to the output circuit 82A. Similarly, the processing circuit 80B may be formed of a buffer amplifier, a differential amplifier, and the like, and has a function of performing predetermined signal processing on the pixel signal of a column selected by the horizontal scanning circuit 70B and outputting the processed pixel data to the output circuit 82B. Examples of the signal processing performed by the processing circuits 80A and 80B include correction processing by corrected double sampling (CDS), amplification processing, and the like.

The output circuit 82A includes an external interface circuit and has a function of outputting the image data input from the processing circuit 80A to the outside of the photoelectric conversion device 100. Similarly, the output circuit 82B includes an external interface circuit and has a function of outputting image data input from the processing circuit 80B to the outside of the photoelectric conversion device 100. The external interface circuits included in the output circuits 82A and 82B are not particularly limited. As the external interface circuit, for example, a serializer/deserializer (SerDes) transmission circuit such as a low voltage differential signaling (LVDS) circuit or a scalable low voltage signaling (SLVS) circuit may be applied.

The control circuit 90 has a function of generating control signals for controlling the operations of the above-described functional blocks and outputting the generated control signals to these functional blocks. At least a part of the control signals for controlling the operation of the functional blocks may be supplied from the outside of the photoelectric conversion device 100.

FIG. 1 illustrates an example in which two readout circuit blocks, a readout circuit block including the readout circuit 40A, the horizontal scanning circuit 70A, the processing circuit 80A, and the like, and a readout circuit block including the readout circuit 40B, the horizontal scanning circuit 70B, the processing circuit 80B, and the like, are provided. However, the number of readout circuit blocks is not necessarily two and may be one.

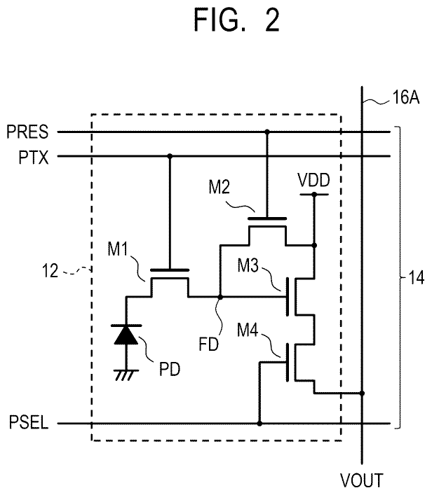

FIG. 2 is a circuit diagram illustrating a configuration example of a pixel in the photoelectric conversion device according to the present embodiment. Each of the pixels 12 included in the pixel array unit 10 may include, for example, as illustrated in FIG. 2, a photoelectric conversion element PD, a transfer transistor M1, a reset transistor M2, an amplifier transistor M3, and a select transistor M4.

The photoelectric conversion element PD is, for example, a photodiode, and has an anode connected to a ground voltage line and a cathode connected to a source of the transfer transistor M1. A drain of the transfer transistor MI is connected to a source of the reset transistor M2 and a gate of the amplifier transistor M3. The node FD to which the drain of the transfer transistor M1, the source of the reset transistor M2, and the gate of the amplifier transistor M3 are connected is a so-called a floating diffusion. The floating diffusion includes a capacitance component (floating diffusion capacitance) and has a function as a charge holding portion. The floating diffusion capacitance may include a gate capacitance of the transistor, a p-n junction capacitance, an interconnection capacitance, and the like. A drain of the reset transistor M2 and a drain of the amplifier transistor M3 are connected to a node to which a power supply voltage (voltage VDD) is supplied. A source of the amplifier transistor M3 is connected to a drain of the select transistor M4. A source of the select transistor M4 is connected to the signal output line 16A (or the signal output line 16B).

In the case of the pixel configuration of FIG. 2, the control line 14 of each row includes three signal lines including a signal line connected to a gate of the transfer transistor M1, a signal line connected to a gate of the reset transistor M2, and a signal line connected to a gate of the select transistor M4. The control signal PTX is supplied from the vertical scanning circuit 20 to the gate of the transfer transistor M1. The control signal PRES is supplied from the vertical scanning circuit 20 to the gate of the reset transistor M2. The control signal PSEL is supplied from the vertical scanning circuit 20 to the gate of the select transistor M4. In the case where each transistor is formed of an n-channel transistor, when a high-level control signal is supplied from the vertical scanning circuit 20, the corresponding transistor is turned on. When a low-level control signal is supplied from the vertical scanning circuit 20, the corresponding transistor is turned off.

The present embodiment will be described on the assumption that electrons among electron-hole pairs generated in the photoelectric conversion element PD by light incidence are used as a signal charge. When electrons are used as the signal charge, each transistor constituting the pixel 12 may be formed of an n-channel transistor. However, the signal charge is not limited to electrons, and holes may be used as the signal charge. When holes are used as the signal charge, the conductivity type of each transistor may be opposite to that described in the present embodiment. The names of the source and the drain of the MOS transistor may vary depending on the conductivity type of the transistor and/or the function of the transistor that focused on. Some or all of the names of the source and the drain used in the present embodiment may be referred to as reverse names. In this specification, one of the source and the drain may be referred to as a first main node, the other of the source and the drain may be referred to as a second main node, and the gate may be referred to as a control node.

The photoelectric conversion element PD converts (photoelectrically converts) the incident light into charge of an amount corresponding to the amount of the incident light and accumulates the generated charge. The transfer transistor M1 transfers the charge held by the photoelectric conversion element PD to the node FD by turning on. The charge transferred from the photoelectric conversion element PD is held in the capacitance component (floating diffusion capacitance) of the node FD. As a result, the node FD becomes a potential corresponding to the amount of charge transferred from the photoelectric conversion element PD by charge-voltage conversion by the floating diffusion capacitance.

The select transistor M4 connects the amplifier transistor M3 to the signal output line 16A (or the signal output line 16B) by turning on. The amplifier transistor M3 has the drain to which the voltage VDD is supplied and the source to which a bias current is supplied from a current source (current sources 441 and 442 to be described later) (not illustrated) via the select transistor M4. Accordingly, the amplifier transistor M3 constitutes an amplification unit (source follower circuit) having the gate as an input node, and outputs a signal based on the potential of the node FD to the signal output line 16A (or the signal output line 16B) via the select transistor M4. In this sense, the amplifier transistor M3 and the select transistor M4 forms an output unit that output a pixel signal according to the amount of charge held in the node FD.

The reset transistor M2 has a function of controlling supply of a voltage (voltage VDD) for resetting the node FD as a charge holding portion to the FD node. The reset transistor M2 resets the node FD to a voltage corresponding to the voltage VDD by turning on.

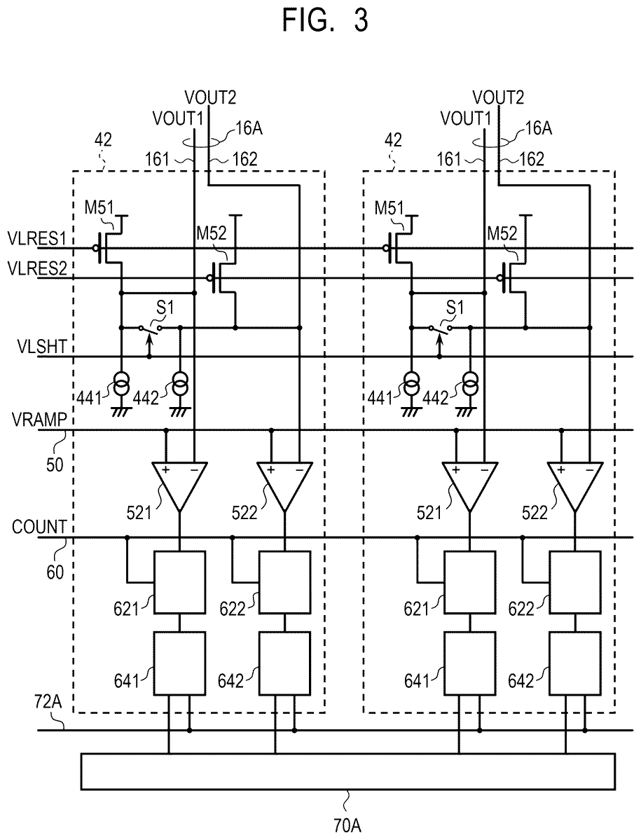

FIG. 3 is a circuit diagram illustrating a configuration example of a column circuit in the photoelectric conversion device according to the present embodiment. FIG. 3 illustrates two of the plurality of column circuits 42 constituting the readout circuit 40A. Two signal lines 161 and 162 constituting the signal output line 16A of each column are connected to the column circuit 42 of the corresponding column. Each of the column circuits 42 may include p-channel transistors M51 and M52, current sources 441 and 442, a switch S1, comparison circuits 521 and 522, and memories 621, 622, 641 and 642, as illustrated in, e.g., FIG. 3. As described above, the current sources 441 and 442 function as load current sources of the amplifier transistor M3 of the pixel 12.

A source of the transistor M51 is connected to a node to which a power supply voltage (voltage VDD) is supplied. A drain of the transistor M51 is connected to the signal line 161, one terminal of the switch S1, and one terminal of the current source 441. The other terminal of the current source 441 is connected to the ground voltage node. A control signal VLRES1 is supplied from the control circuit 90 to a gate of the transistor M51. A source of the transistor M52 is connected to a node to which the power supply voltage (voltage VDD) is supplied. A drain of the transistor M52 is connected to the signal line 162, the other terminal of the switch S1, and one terminal of the current source 442. The other terminal of the current source 442 is connected to the ground voltage node. A control signal VLRES2 is supplied from the control circuit 90 to a gate of the transistor M52. A control signal VLSHT is supplied from the control circuit 90 to a control node of the switch S1. The control signals VLRES1, VLRES2, and VLSHT are signals common to the column circuits 42 of the respective columns. The voltage supplied to the sources of the transistors M51 and M52 may be a fixed voltage other than the power supply voltage.

The transistor M51 is turned off when a high-level control signal VLRES1 is supplied from the control circuit 90 and is turned on when a low-level control signal VLRES1 is supplied from the control circuit 90. Similarly, the transistor M52 is turned off when a high-level control signal VLRES2 is supplied from the control circuit 90 and is turned on when a low-level control signal VLRES2 is supplied from the control circuit 90. The transistors M51 and M52 function as a voltage control unit that controls supply of a voltage to the signal lines 161 and 162.

The switch S1 is turned on when a high-level control signal VLSHT is supplied from the control circuit 90 and is turned off when a low-level control signal VLSHT is supplied from the control circuit 90. The switch S1 functions as a switch circuit that controls electrical connection and separation between the signal lines 161 and 162.

The comparison circuit 521 includes two input nodes (a non-inverting input node (+) and an inverting input node (−)) to which two signals to be compared are input, and one output node to which a signal indicating a comparison result is output, and may be comprised of, for example, a differential amplifier circuit. One input node (inversion input node) of the comparison circuit 521 is connected to the signal line 161, and the voltage VOUT1 which is an output signal of the pixel 12 is input via the signal line 161. The other input node (non-inverting input node) of the comparison circuit 521 is connected to the reference signal line 50. The reference signal VRAMP is input to the other input node of the comparison circuit 521 from the reference signal output circuit 48A via the reference signal line 50.

Similarly, the comparison circuit 522 includes two input nodes (a non-inverting input node (+) and an inverting input node (−)) to which two signals to be compared are input, and one output node to which a signal indicating a comparison result is output, and may be comprised of, for example, a differential amplifier circuit. One input node (inversion input node) of the comparison circuit 522 is connected to the signal line 162, and the voltage VOUT2 which is an output signal of the pixel 12 is input via the signal line 162. The other input node (non-inverting input node) of the comparison circuit 522 is connected to the reference signal line 50. The reference signal VRAMP is input to the other input node of the comparison circuit 522 from the reference signal output circuit 48A via the reference signal line 50.

The memory 621 has two input nodes and one output node. The memory 641 has two input nodes and one output node. One input node of the memory 621 is connected to the output node of the comparison circuit 521. The other input node of the memory 621 is connected to a count signal line 60. The count signal COUNT is input to the other input node of the memory 621 from the counter circuit 58A via the count signal line 60. One input node of the memory 641 is connected to the output node of the memory 621. The other input node of the memory 641 is connected to the horizontal scanning circuit 70A. The output node of the memory 641 is connected to the horizontal output line 72A.

Similarly, the memory 622 has two input nodes and one output node. The memory 642 has two input nodes and one output node. One input node of the memory 622 is connected to the output node of the comparison circuit 522. The other input node of the memory 622 is connected to the count signal line 60. The count signal COUNT is input to the other input node of the memory 622 from the counter circuit 58A via the count signal line 60. One input node of the memory 642 is connected to the output node of the memory 622. The other input node of the memory 642 is connected to the horizontal scanning circuit 70A. The output node of the memory 642 is connected to the horizontal output line 72A.

The comparison circuit 521 compares the level of the voltage VOUT1 output from the signal line 161 with the level of the reference signal VRAMP supplied from the reference signal line 50, and outputs a signal according to the comparison result. For example, the comparison circuit 521 outputs a high-level signal when the level of the reference signal VRAMP is lower than the level of the voltage VOUT1. When the level of the reference signal VRAMP is higher than the level of the voltage VOUT1, the comparison circuit 521 outputs a low-level signal. The relationship between the magnitudes of the input signals and the level of the output signal may be reversed.

The memory 621 holds the count value indicated by the count signal COUNT supplied from the counter circuit 58A at a timing when the level of the output node of the comparison circuit 521 is inverted, as digital data of the pixel signal. That is, the comparison circuit 521 and the counter circuit 58A function as an analog-to-digital conversion circuit that converts an analog signal output to the signal line 161 into a digital signal. The memory 641 holds digital data of the pixel signal transferred from the memory 621. The digital data held in the memory 641 is sequentially transferred to the processing circuit 80A via the horizontal output line 72A for each column in accordance with the control signal supplied from the horizontal scanning circuit 70A. By providing the memory 641 in the subsequent stage of the memory 621, the analog-to-digital conversion operation may be performed in parallel with the transfer operation to the processing circuit 80A.

Instead of providing the counter circuit 58A, the memory 621 of the column circuit 42 may have a function of a counter circuit. In this case, the memory 621 of the column circuit 42 of each column receives the common clock signal output from the control circuit 90 and counts the pulses of the clock signal. The count value at the timing when the level of the output signal of the comparison circuit 521 is inverted is digital data held in the memory 621.

The configuration and operation of the comparison circuit 522, the memory 622, and the memory 642 are similar to those of the comparison circuit 521, the memory 621, and the memory 641 except that one input node (inversion input node) of the comparison circuit 522 is connected to the signal line 162.

The column circuit 42 of the readout circuit 40B is the same as the column circuit 42 of the readout circuit 40A except that the column circuit 42 of the readout circuit 40B is arranged in a column different from the column in which the column circuit 42 of the readout circuit 40A is arranged, and thus description thereof is omitted. Hereinafter, the column circuit 42 of the readout circuit 40A will be described, but the same applies to the column circuit 42 of the readout circuit 40B. In addition, in the following description, when the signal output lines 16A and 16B, the readout circuits 40A and 40B, and the like are commonly described, A and B in the reference signs are appropriately omitted, and they may be referred to as the signal output line 16, the readout circuit 40, and the like. In the case where a plurality of similar constituent elements is provided, a serial number such as 1, 2, 3, . . . is given to each reference numeral, and these may be distinguished from each other.

The photoelectric conversion device 100 of the present embodiment may have a configuration in which all the functional blocks described above are disposed on one substrate or may have a configuration in which functional blocks are separately formed on each substrate as a stacked type in which a plurality of substrates is stacked.

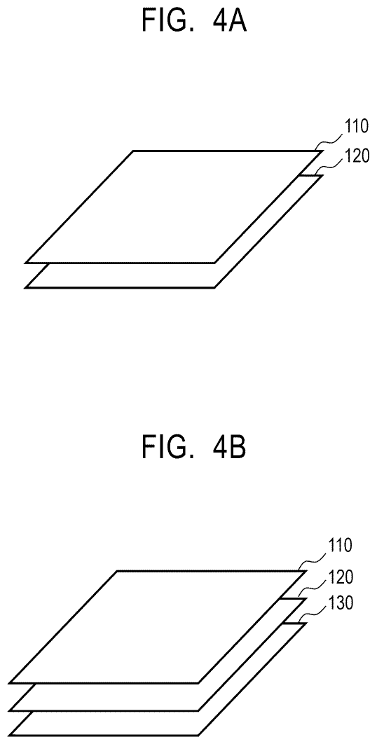

FIG. 4A and FIG. 4B are schematic diagrams illustrating a configuration example of the photoelectric conversion device according to the present embodiment. FIG. 4A is a schematic diagram of a case where the pixel substrate 110 on which the pixel array unit 10 is disposed and the circuit substrate 120 on which other functional blocks are disposed are stacked. By arranging the pixel substrate 110 and the circuit substrate 120 on different substrates, it is possible to reduce the size of the photoelectric conversion device 100 without sacrificing the area of the pixel array unit 10. FIG. 4B is a schematic diagram of a case where the pixel substrate 110 on which the pixel array unit 10 is disposed and circuit substrates 120 and 130 on which other functional blocks are disposed are stacked. Also in this case, it is possible to reduce the size of the photoelectric conversion device 100 without sacrificing the area of the pixel array unit 10.

In addition, when the pixel array unit 10 and the p-channel transistors M51 and M52 constituting the column circuit 42 are provided on different substrates, the transistors constituting the pixel substrate 110 are only n-channel pixel transistors. Thus, in the pixel substrate 110, the manufacturing process of the p-channel transistors may be omitted, and thus the manufacturing process may be simplified.

The circuit elements constituting one functional block are not necessarily arranged on the same substrate and may be arranged on different substrates.

Next, as an example of the operation of the photoelectric conversion device 100 according to the present embodiment, an operation mode in which signals of the pixels 12 of one row are sequentially read out by alternately using the two signal lines 161 and 162 constituting the signal output lines 16A and 16B of each column will be described.

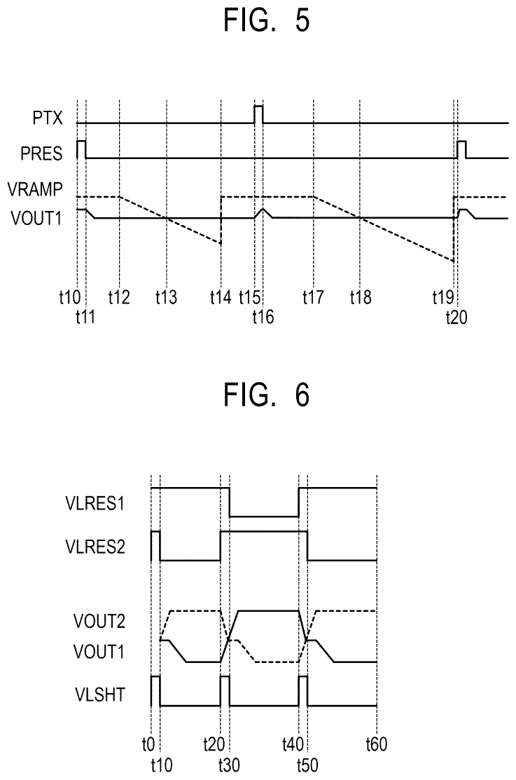

First, an operation in the case of reading out a signal of the pixel 12 connected to the signal line 161 will be described with reference to FIG. 5. FIG. 5 is a timing chart illustrating a method of driving the photoelectric conversion device according to the present embodiment. The timing chart of FIG. 5 illustrates waveforms of the control signals PTX and PRES, the reference signal VRAMP, and the voltage VOUT1 of the signal line 161.

When a signal is read out from the pixel 12 connected to the signal line 161, the current source 441 and the comparison circuit 521 are set to an operation state, and the current source 442 and the comparison circuit 522 are set to a power saving state, whereby power in operation may be reduced. At this time, the transistor M52 is turned on to fix the voltage of the signal line 162 to the power supply voltage so that the potential of the unused signal line 162 does not become floating. The power saving state includes stopping the supply of the power supply voltage and preventing a through-current from flowing from the power supply voltage node to the ground node. The power saving state referred to in this specification includes a mode in which the power consumption of a circuit to be controlled is zero but is not limited to this mode. That is, the power consumption of the control target circuit may be smaller than that in the normal operation state. In the case where the power consumption is set to zero, although it may take time to return to the operation state, the return to the operation state may be speeded up by setting the power consumption to a state smaller than that in the normal operation state without setting the power consumption to zero. Note that a state in which the power saving state is less than the normal operation state may be a power consumption of 50% or less of the normal operation state. Further, in order to further suppress power consumption, power consumption in the power saving state may be 20% or less of power consumption in the normal operation state.

Just before time t10, the control signal PSEL (not illustrated) of the row to be read out including the pixel 12 connected to the signal line 161 is at high-level. As a result, the select transistors M4 of the pixels 12 belonging to the row are turned on, and each of the pixels 12 is in a state capable of outputting a pixel signal to the signal output line 16A of the corresponding column. Also, just before time t10, the control signals PTX and PRES of the row to be read out are at low-level, and the reference signal VRAMP is at a predetermined initial voltage.

In a period from the time t10 to time t11, the vertical scanning circuit 20 controls the control signal PRES of the row to be read out to high-level. As a result, each of the reset transistors M2 of the pixels 12 belonging to the row is turned on, and the node FD is reset to a voltage corresponding to the voltage VDD. A voltage VOUT1 corresponding to the reset voltage of the node FD (a pixel signal of a reset level of the pixel 12) is output to each of the signal line 161 connected to the pixels 12 of the row to be read out.

When the control signal PRES is changed from low-level to high-level at the time t10, the voltage of the node FD increases due to a capacitive coupling between the gate and the source of the reset transistor M2, and the voltage VOUT1 also increases accordingly. Further, when the control signal PRES is changed from high-level to low-level at the time t11, the voltage of the node FD decreases due to the capacitive coupling between the gate and the source of the reset transistor M2, and the voltage VOUT1 also decreases accordingly.

At the subsequent time t12, the reference signal output circuit 48A starts a slope operation of gradually decreasing the voltage of the reference signal VRAMP with time. The counter circuit 58A starts counting up simultaneously with the start of the slope operation, and outputs a count signal COUNT indicating the count value to the column circuit 42 of each column via the count signal line 60.

The comparison circuit 521 of the column circuit 42 compares the level of the voltage VOUT1 with the level of the reference signal VRAMP. The level of the output signal of the comparison circuit 521 is inverted at a timing when the magnitude relationship between the level of the voltage VOUT1 and the level of the reference signal VRAMP changes, for example, at time t13 in FIG. 5.

The memory 621 of the column circuit 42 holds the count value indicated by the count signal COUNT output from the counter circuit 58A at the timing when the level of the output signal of the comparison circuit 521 is inverted as digital data of the pixel signal of the reset level of the pixel 12. In this way, AD conversion is performed on the pixel signal of the reset level of the pixel 12. The digital data held in the memory 621 is transferred to the memory 641 and then transferred to the processing circuit 80A in accordance with the control signal from the horizontal scanning circuit 70A.

At the subsequent time t14, the reference signal output circuit 48A resets the reference signal VRAMP to the level of the initial voltage.

In the subsequent period from time t15 to time t16, the vertical scanning circuit 20 controls the control signal PTX of the row to be read out to high-level. Accordingly, each of the transfer transistors M1 of the pixels 12 belonging to the row is turned on, and the charge accumulated in the photoelectric conversion element PD during a predetermined exposure period is transferred to the node FD. Accordingly, the voltage of the node FD decreases in accordance with the amount of charge transferred from the photoelectric conversion element PD, and the voltage VOUT1 of the signal line 161 also decreases. A voltage VOUT1 corresponding to the voltage of the node FD (a pixel signal at a light signal level of the pixel 12) is output to the signal line 161. Note that FIG. 5 illustrates a waveform in a case corresponding to dark state, and it is assumed that the signal level is settled to the reset level substantially the same level as time t12 after time t16.

When the control signal PTX is changed from low-level to high-level at the time t15, the voltage of the node FD increases due to a capacitive coupling between the gate and the drain of the transfer transistor M1, and the voltage VOUT1 also increases accordingly. Further, when the control signal PTX is changed from high-level to low-level at the time t16, the voltage of the node FD decreases due to the capacitive coupling between the gate and the drain of the transfer transistor M1, and the voltage VOUT1 also decreases accordingly.

At the subsequent time t17, the reference signal output circuit 48A starts a slope operation of gradually decreasing the voltage of the reference signal VRAMP with time. The counter circuit 58A starts counting up simultaneously with the start of the slope operation, and outputs a count signal COUNT indicating the count value to the column circuit 42 of each column via the count signal line 60.

The comparison circuit 521 of the column circuit 42 compares the level of the voltage VOUT1 with the level of the reference signal VRAMP. The level of the output signal of the comparison circuit 521 is inverted at a timing when the magnitude relationship between the level of the voltage VOUT1 and the level of the reference signal VRAMP changes, for example, at time t18 in FIG. 5.

The memory 621 of the column circuit 42 holds the count value indicated by the count signal COUNT output from the counter circuit 58A at the timing when the level of the output signal of the comparison circuit 521 is inverted as digital data of the pixel signal of the light signal level of the pixel 12. In this way, AD conversion is performed on the pixel signal of the light signal level of the pixel 12. The digital data held in the memory 621 is transferred to the memory 641 and then transferred to the processing circuit 80A in accordance with the control signal from the horizontal scanning circuit 70A.

The digital data of the pixel signal thus acquired is subjected to correction processing by digital CDS (Correlated Double Sampling) in the subsequent processing circuit 80A. In the correction processing by the digital CDS, the digital data of the pixel signal of the reset level is subtracted from the digital data of the pixel signal of the light signal level, and the noise component superimposed on the pixel signal of the light signal level is removed.

At the subsequent time t19, the reference signal output circuit 48A resets the reference signal VRAMP to the level of the initial voltage.

As described above, during a predetermined unit period (from time t10 to time t20), the pixel signals of the pixels 12 connected to the signal lines 161 are read out via the signal lines 161. The readout operation of the pixel signal of the pixel 12 connected to the signal line 162 is performed in the same procedure, except that the current source 442 and the comparison circuit 522 are in the operation state, the current source 441 and the comparison circuit 521 are in the power saving state, the transistor M52 is turned off, and the transistor M51 is turned on.

Next, a switching operation between the readout operation of the pixel signal output to the signal line 161 and the readout operation of the pixel signal output to the signal line 162 will be described with reference to FIG. 6. FIG. 6 is a timing chart illustrating a method of driving the photoelectric conversion device according to the present embodiment. The timing chart of FIG. 6 illustrates waveforms of the control signals VLRES1, VLRES2, and VLSHT, the voltage VOUT1 of the signal line 161, and the voltage VOUT2 of the signal line 162. In FIG. 6, a solid line represents the voltage VOUT1, and a broken line represents the voltage VOUT2.

In FIG. 6, a period from time t10 to time t20 and a period from time t50 to time t60 correspond to a period in which a pixel signal readout operation of the pixel 12 connected to the signal line 161 is performed. A period from time t30 to time t40 corresponds to a period in which a pixel signal readout operation of the pixel 12 connected to the signal line 162 is performed.

In a period from time to the time t10, the control circuit 90 controls the control signals VLRES1, VLRES2, and VLSHT to high-level. Thus, the transistors M51 and M52 are turned off and the switch S1 is turned on, so that the signal line 161 and the signal line 162 are connected to each other via the switch S1 and have the same potential.

At the subsequent time t10, the control circuit 90 controls the control signals VLRES2 and VLSHT from high-level to low-level to turn on the transistor M52 and turn off the switch S1. As a result, the voltage of the signal line 162 is fixed to the power supply voltage via the transistor M52, and the signal line 161 is electrically disconnected from the signal line 162 so that the pixel signal may be read out.

The operation of the pixel 12 and the column circuit 42 in the period from the time t10 to the time t20 is as described with reference to FIG. 5. That is, in the period from the time t10 to the time t20, the readout operation of the pixel signal from the pixel 12 via the signal line 161 is performed.

At the subsequent time t20, the control circuit 90 controls the control signal VLRES2 from low-level to high-level to turn off the transistor M52. As a result, the voltage supply from the power supply voltage node to the signal line 162 is cut off, and the charge accumulated in the parasitic capacitance accompanying the signal line 162 is discharged through the current source 442, whereby the potential of the signal line 162 starts to decrease from the power supply voltage.

Similarly, at the time t20, the control circuit 90 controls the control signal VLSHT from low-level to high-level to turn on the switch S1. As a result, the signal line 161 and the signal line 162 are short-circuited via the switch S1.

When the pixel signal is read out from the signal line 162 in the period from the time t30 to the time t40, it is necessary to reduce the potential of the signal line 162 from the power supply voltage to the reset level (it corresponds to the level of the voltage VOUT1 in the period from the time t10 to the time t11 in FIG. 5). However, since the settling of the voltage VOUT2 takes a certain period of time, there is a concern that the readout speed may decrease.

In this regard, in the present embodiment, by performing the above-described short-circuit operation in the period from the time t20 to the time t30, the charge is distributed between the signal line 161 and the signal line 162, and the increase in the potential of the signal line 161 and the decrease in the potential of the signal line 162 are promoted. By additionally performing such an operation, it is possible to reduce the length of a period until the potential of the signal line 162 is settled to the reset level.

At the subsequent time t30, the control circuit 90 controls the control signals VLRES1 and VLSHT from high-level to low-level to turn on the transistor M51 and turn off the switch S1. As a result, the voltage of the signal line 161 is fixed to the power supply voltage via the transistor M51, and the signal line 162 is electrically disconnected from the signal line 161 so that the pixel signal may be read out.

In a period from the time t30 to the time t40, an operation of reading out a pixel signal from the pixel 12 via the signal line 162 is performed. The operation of the pixel 12 and the column circuit 42 in the period from the time t30 to the time t40 is performed in the same procedure as that in the period from the time t10 to the time t20 as described above.

At the subsequent time t40, the control circuit 90 controls the control signal VLRES1 from low-level to high-level to turn off the transistor M51. As a result, the voltage supply from the power supply voltage node to the signal line 161 is cut off, and the charge accumulated in the parasitic capacitance accompanying the signal line 161 is discharged through the current source 441, whereby the potential of the signal line 161 starts to decrease from the power supply voltage.

Also, at the time t40, the control circuit 90 controls the control signal VLSHT from low-level to high-level to turn on the switch S1. As a result, the signal line 161 and the signal line 162 are short-circuited via the switch S1.

When the pixel signal is read out from the signal line 161 in the period from the time t50 to the time t60, the potential of the signal line 161 needs to be lowered from the power supply voltage to the reset level. However, since the settling of the voltage VOUT1 takes a certain period of time, there is a concern that the readout speed may decrease.

In this regard, in the present embodiment, by performing the above-described short-circuit operation in the period from the time t40 to the time t50, the charge is distributed between the signal line 161 and the signal line 162, and the decrease in the potential of the signal line 161 and the increase in the potential of the signal line 162 are promoted. By additionally performing such an operation, it is possible to reduce the length of a period until the potential of the signal line 161 is settled to the reset level.

The operation after the time t50 is the same as the operation from the time 10.

As described above, in the present embodiment, when the pixel signal is read out to the signal line 161, a predetermined voltage is applied to the signal line 162 in the same column. When a pixel signal is read out to the signal line 162, a predetermined voltage is applied to the signal line 161 in the same column. The signal line 161 and the signal line 162 are short-circuited between a period in which a pixel signal is read out to the signal line 161 and a period in which a pixel signal is read out to the signal line 162. Accordingly, the length of the period until the potentials of the signal lines 161 and 162 are settled to the reset level may be reduced, and the speed of the readout operation may be increased. In particular, in the case where the readout operation of the pixel signal to the signal line 161 and the readout operation of the pixel signal to the signal line 162 are alternately switched, the effect of speeding up the readout operation is great.

Note that the photoelectric conversion device 100 according to the present embodiment may simultaneously use the two signal lines 161 and 162 constituting the signal output lines 16A and 16B of each column to perform an operation of reading out signals of the pixels 12 of two rows in parallel. In the operation mode in which the two signal lines 161 and 162 are simultaneously used, the switch S1 and the transistors M51 and M52 are set to the off state. In this state, the signals of the pixels 12 may be output in parallel to the signal lines 161 and 162, and the signals may be read out in parallel to the comparison circuits 521 and 522.

As described above, according to the present embodiment, in a photoelectric conversion device in which a plurality of signal output lines is arranged in each column of a pixel array, it is possible to improve the speed of reading out signals from pixels.

In the present embodiment, the case where the signal output line 16 of each column includes two signal lines has been described, but the same configuration as that of the present embodiment may also be applied to a case where the signal output line 16 of each column includes three or more signal lines. For example, in the case where the signal output line 16 of each column includes three signal lines of a first signal line, a second signal line, and a third signal line, signals are read out from the first signal line, the second signal line, and the third signal line in a first period, a second period, and a third period, respectively. In each period, signal lines for reading out are short-circuited at least in periods before and after the period. In this case, the number of switches S1 connected to each signal line is preferably the same. With this configuration, the influence of turning off the switch S1 may be made uniform between the signal lines, and degradation in image quality may be suppressed.

### Second Embodiment

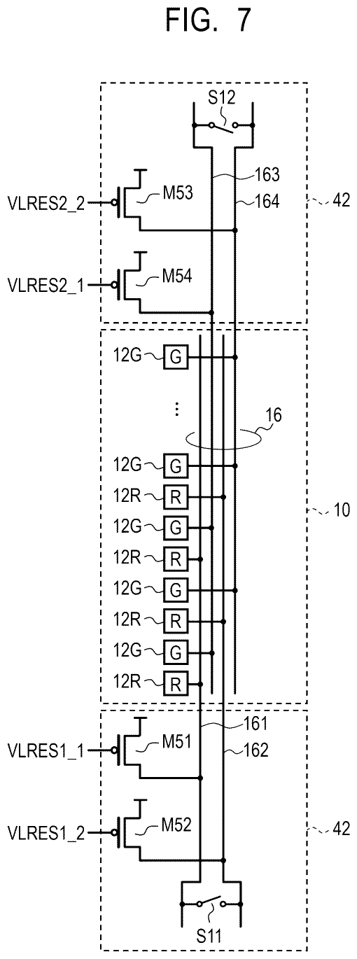

A photoelectric conversion device and a method of driving the same according to a second embodiment of the present invention will be described with reference to FIG. 7. The same components as those of the photoelectric conversion device according to the first embodiment are denoted by the same reference numerals, and description thereof will be omitted or simplified. In the present embodiment, differences from the photoelectric conversion device according to the first embodiment will be mainly described, and description of points similar to those of the photoelectric conversion device according to the first embodiment will be appropriately omitted.

FIG. 7 is a schematic diagram illustrating a configuration example of the photoelectric conversion device according to the present embodiment. FIG. 7 illustrates a part of the pixel array unit 10 and a part of the column circuit 42 among the components of the photoelectric conversion device according to the present embodiment. In the present embodiment, it is assumed that the pixel array unit 10 includes color filters arranged according to a so-called Bayer arrangement. FIG. 7 illustrates one column in which pixels 12R having sensitivity to red light and pixels 12G having sensitivity to green light are alternately arranged among a plurality of columns constituting the pixel array unit 10. In addition, the column circuit 42 illustrates only the constituent elements corresponding to the transistors M51 and M52 and the switch S1 in the first embodiment among the constituent elements of the column circuit 42 corresponding to the one column.

In the photoelectric conversion device according to the present embodiment, as illustrated in FIG. 7, the signal output lines 16 arranged in each column of the pixel array unit 10 include four signal lines 161, 162, 163 and 164. The column circuit 42 includes a transistor M51 connected to the signal line 161, a transistor M52 connected to the signal line 162, a transistor M53 connected to the signal line 163, and a transistor M54 connected to the signal line 164. The column circuit 42 further includes a switch S11 connected between the signal line 161 and the signal line 162 and a switch S12 connected between the signal line 163 and the signal line 164. The transistors M51, M52, M53, and M54 are transistors corresponding to the transistors M51 and M52 of the first embodiment and have a function of fixing the voltage of the corresponding signal line to the power supply voltage by being turned on. The switches S11 and S12 are switches corresponding to the switch S1 of the first embodiment and have a function of short-circuiting between corresponding signal lines by being turned on.

The plurality of pixels 12R included in the pixel array unit 10 is divided into pixels 12R connected to the signal line 161 and pixels 12R connected to the signal line 162 in units of rows. Similarly, the plurality of pixels 12G constituting the pixel array unit 10 is divided into pixels 12G connected to the signal line 163 and pixels 12G connected to the signal line 164 in units of rows.

The switches S11 and S12 are connected between signal lines to which the pixels 12 of the same color are connected. That is, the switch S11 is connected between the signal line 161 to which the pixel 12R is connected and the signal line 162 to which the pixel 12R is connected. The switch S12 is connected between the signal line 163 to which the pixel 12G is connected and the signal line 164 to which the pixel 12G is connected.

Although not illustrated in FIG. 7, a column (not illustrated) in which the pixels 12B having sensitivity to blue light and the pixels 12G having sensitivity to green light are alternately arranged is the same as a column in which the pixels 12R and the pixels 12G are alternately arranged.

When the operation of the first embodiment is applied to the photoelectric conversion device of the present embodiment, the readout operation from the pixel 12R to the signal line 161 and the readout operation from the pixel 12R to the signal line 162 are alternately performed. Further, in parallel with this, the readout operation from the pixel 12G to the signal line 163 and the readout operation from the pixel 12G to the signal line 164 are alternately performed. For example, the control signals VLRES1_1 and VLRES2_1 in FIG. 7 may be controlled by the same waveform as the control signal VLRES1 in FIG. 6, and the control signals VLRES1_2 and VLRES2_2 may be controlled by the same waveform as the control signal VLRES2 in FIG. 6. Then, the switch S11 is turned on at a predetermined timing at which the readout operation to the signal line 161 and the readout operation to the signal line 162 are switched to short-circuit the signal line 161 and the signal line 162. In addition, the switch S12 is turned on at a predetermined timing at which the readout operation to the signal line 163 and the readout operation to the signal line 164 are switched to short-circuit the signal line 163 and the signal line 164.

Thus, as in the case of the first embodiment, the readout operation of the pixel signal may be speeded up. Further, when the readout operation is switched, it is possible to prevent color mixture by independently short-circuiting the signal lines that output the signals of the pixels 12 of the same color.

As described above, according to the present embodiment, in a photoelectric conversion device in which a plurality of signal output lines is arranged in each column of a pixel array, it is possible to improve the speed of reading out signals from pixels.

### Third Embodiment

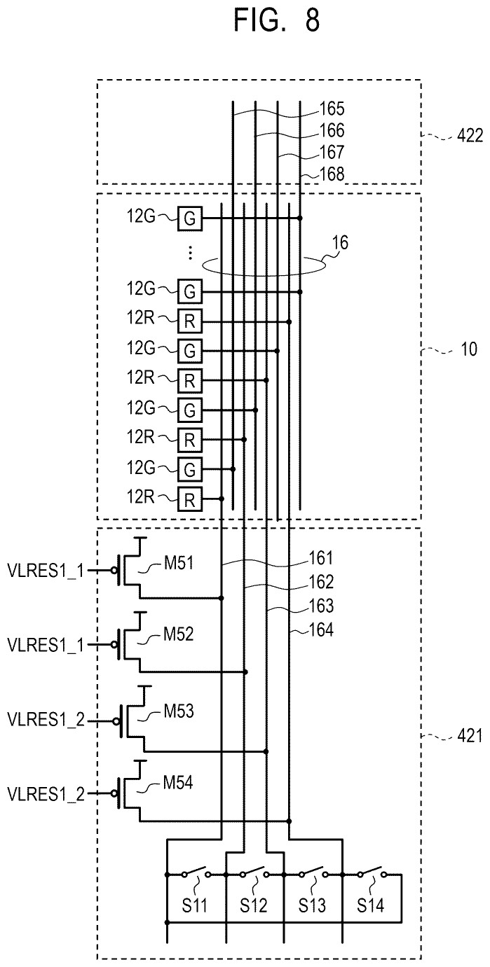

A photoelectric conversion device and a method of driving the same according to a third embodiment of the present invention will be described with reference to FIG. 8. The same components as those of the photoelectric conversion device according to the first or second embodiment are denoted by the same reference numerals, and description thereof will be omitted or simplified. In the present embodiment, differences from the photoelectric conversion device according to the first or second embodiment will be mainly described, and description of points similar to those of the photoelectric conversion device according to the first or second embodiment will be appropriately omitted.

FIG. 8 is a schematic diagram illustrating a configuration example of the photoelectric conversion device according to the present embodiment. FIG. 8 illustrates a part of the pixel array unit 10 and a part of the column circuit 42 among the components of the photoelectric conversion device according to the present embodiment. Also in the present embodiment, as in the second embodiment, the pixel array unit 10 including the color filters arranged according to the Bayer arrangement is assumed. FIG. 8 illustrates one column in which the pixels 12R and the pixels 12G are alternately arranged among a plurality of columns constituting the pixel array unit 10. In addition, the column circuit 42 illustrates only the constituent elements corresponding to the transistors M51 and M52 and the switch S1 in the first embodiment among the constituent elements of the column circuit 42 corresponding to the one column.

In the photoelectric conversion device according to the present embodiment, as illustrated in FIG. 8, the signal output lines 16 arranged in each column of the pixel array unit 10 have eight signal lines 161, 162, 163, 164, 165, 166, 167 and 168. The column circuit 42 includes a column circuit 421 connected to the signal lines 161, 162, 163 and 164 and a column circuit 422 connected to the signal lines 165, 166, 167 and 168. The column circuit 421 includes a transistor M51 connected to the signal line 161, a transistor M52 connected to the signal line 162, a transistor M53 connected to the signal line 163, and a transistor M54 connected to the signal line 164. The column circuit 421 includes a switch S11 connected between the signal line 161 and the signal line 162 and a switch S12 connected between the signal line 162 and the signal line 163. The column circuit 421 further includes a switch S13 connected between the signal line 163 and the signal line 164 and a switch S14 connected between the signal line 164 and the signal line 161

The transistors M51, M52, M53, and M54 are transistors corresponding to the transistors M51 and M52 of the first embodiment and have a function of fixing the voltage of the corresponding signal line to the power supply voltage by being turned on. The switches S11, S12, S13, and S14 are switches corresponding to the switch S1 of the first embodiment and have a function of short-circuiting corresponding signal lines by being turned on.

The plurality of pixels 12R included in the pixel array unit 10 is divided into a pixel 12R connected to a signal line 161, a pixel 12R connected to a signal line 162, a pixel 12R connected to a signal line 163, and a pixel 12R connected to a signal line 164 in units of rows. Similarly, the plurality of pixels 12G included in the pixel array unit 10 is divided into a pixel 12G connected to the signal line 165, a pixel 12G connected to the signal line 166, a pixel 12G connected to the signal line 167, and a pixel 12G connected to the signal line 168 in units of rows.

The switches S11, S12, S13, and S14 are connected between signal lines to which the pixels 12 of the same color are connected. That is, the switch S11 is connected between the signal line 161 to which the pixel 12R is connected and the signal line 162 to which the pixel 12R is connected. The switch S12 is connected between the signal line 162 to which the pixel 12R is connected and the signal line 163 to which the pixel 12R is connected. The switch S13 is connected between the signal line 163 to which the pixel 12R is connected and the signal line 164 to which the pixel 12R is connected. The switch S14 is connected between the signal line 164 to which the pixel 12R is connected and the signal line 161 to which the pixel 12R is connected.

Since the column circuit 422 is similar to the column circuit 421 except that the signal line to be connected is different, illustration and description of the constituent elements are omitted. Although not illustrated in FIG. 7, a column in which the pixels 12B having sensitivity to blue light and the pixels 12G having sensitivity to green light are alternately arranged is also the same as a column in which the pixels 12R and the pixels 12G are alternately arranged.

When the operation of the first embodiment is applied to the photoelectric conversion device of the present embodiment, the readout operation from the pixel 12R to the signal lines 161 and 162 and the readout operation from the pixel 12R to the signal lines 163 and 164 are alternately performed. Further, in parallel with this, the readout operation from the pixel 12G to the signal lines 165 and 166 and the readout operation from the pixel 12G to the signal lines 167 and 168 are alternately performed. For example, the control signals VLRES1_1 and VLRES2_1 in FIG. 8 may be controlled by the same waveform as the control signal VLRES1 in FIG. 6, and the control signals VLRES1_2 and VLRES2_2 may be controlled by the same waveform as the control signal VLRES2 in FIG. 6. The switches S11, S12, S13, and S14 are turned on at a predetermined timing to switch the readout operation to the signal lines 161 and 162 and the readout operation to the signal lines 163 and 164, so that the signal lines 161, 162, 163 and 164 are short-circuited. The signal lines 165, 166, 167 and 168 are short-circuited at a predetermined timing to switch the readout operation to the signal lines 165 and 166 and the readout operation to the signal lines 167 and 168.

Thus, as in the case of the first embodiment, the readout operation of the pixel signal may be speeded up. In addition, color mixture may be prevented by using a signal line that outputs the signal of the pixel 12 of the same color as the signal line that is short-circuited when the readout operation is switched.

In the present embodiment, the number of signal lines to be short-circuited (e.g., four signal lines 161, 162, 163 and 164) is equal to the number of switches used therein (e.g., four switches S11, S12, S13, and S14). With this configuration, the influence of turning off the switch may be made uniform between the signal lines. For example, although the signal lines 161, 162, 163 and 164 may be short-circuited without the switch S14, the signal lines 161 and 164 and the signal lines 162 and 163 are affected differently when the switches are turned off, which may cause deterioration in image quality. By providing the same number of switches as the number of signal lines to be short-circuited as in the present embodiment, image quality degradation may be suppressed.

As described above, according to the present embodiment, in a photoelectric conversion device in which a plurality of signal output lines is arranged in each column of a pixel array, it is possible to improve the speed of reading out signals from pixels.

### Fourth Embodiment

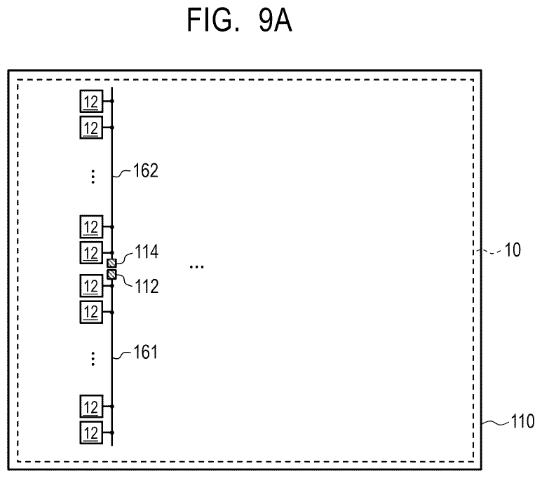

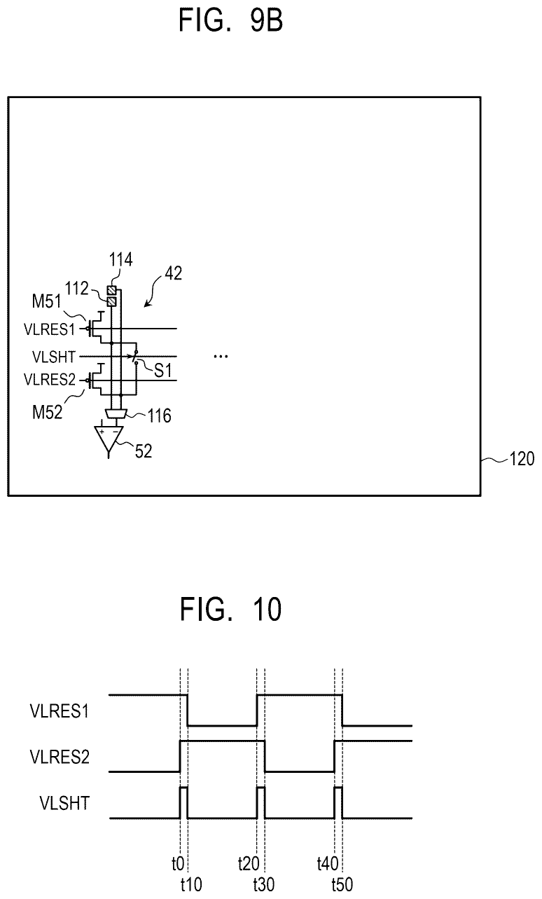

A photoelectric conversion device and a method driving the same according to a fourth embodiment of the present invention will be described with reference to FIG. 9A to FIG. 10. The same components as those of the photoelectric conversion devices according to the first to third embodiments are denoted by the same reference numerals, and description thereof will be omitted or simplified. In the present embodiment, differences from the photoelectric conversion devices according to the first to third embodiments will be mainly described, and description of points similar to those of the photoelectric conversion devices according to the first to third embodiments will be appropriately omitted.

In the present embodiment, a connection example between the pixel array unit 10 and the column circuits in a case where the photoelectric conversion device is configured by a plurality of substrates will be described. In the present embodiment, differences from the photoelectric conversion device of the first embodiment will be mainly described, and description of portions similar to those of the photoelectric conversion device of the first embodiment will be appropriately omitted.

The photoelectric conversion device of the present embodiment is a stacked-type photoelectric conversion device including a pixel substrate 110 on which the pixel array unit 10 is disposed and a circuit substrate 120 on which other circuit blocks are disposed. FIG. 9A and FIG. 9B are schematic diagrams illustrating a configuration example of the photoelectric conversion device according to the present embodiment. FIG. 9A is a plan view of the pixel substrate 110, and FIG. 9B is a plan view of the circuit substrate 120. The photoelectric conversion device of the present embodiment is configured by stacking these substrates so as to overlap each other in a planar manner. FIG. 9A and FIG. 9B illustrate a plurality of pixels 12 arranged in one of a plurality of columns constituting the pixel array unit 10, and some components of the column circuit 42 corresponding to the plurality of pixels 12. In the configuration example of FIG. 9A and FIG. 9B, the plurality of pixels 12 is divided into two groups in the column direction, and these two groups are connected to the signal lines 161 and 162, respectively. The signal lines 161 and 162 are connected to the column circuit 42 provided on the circuit substrate 120 via the electrical connection portions 112 and 114 between the pixel substrate 110 and the circuit substrate 120. The signal lines 161 and 162 are connected to an inverting input node of the common comparison circuit 52 via a multiplexer 116 (selection circuit) provided on the circuit substrate 120. The connection relationships between the transistors M51 and M52 and the switch S1, and the signal lines 161 and 162 are the same as in the first embodiment.

Next, a switching operation between the readout operation of the pixel signal output to the signal line 161 and the readout operation of the pixel signal of the pixel 12 output to the signal line 162 will be described with reference to FIG. 10. FIG. 10 is a timing chart illustrating a method of driving the photoelectric conversion device according to the present embodiment. The timing chart of FIG. 10 illustrates waveforms of the control signals VLRES1, VLRES2, and VLSHT.

In FIG. 10, a period from time t10 to time t20 corresponds to a period in which an operation of reading out a pixel signal to the signal line 161 is performed, and a period from time t30 to time t40 corresponds to a period in which an operation of reading out a pixel signal to the signal line 162 is performed.

In a period before time to, the control signal VLRES1 is at high-level, the control signals VLRES2 and VLSHT are at low-level, the transistor M51 and the switch S1 are off-state, and the transistor M52 is on-state. That is, the potential of the signal line 162 is fixed to the power supply voltage, and the signal line 161 is electrically disconnected from the signal line 162. The multiplexer 116 selects the signal line 161 and may output the signals of the pixels 12 connected to the signal line 161 to the comparison circuit 52. Thus, the pixel signals output to the signal line 161 may be read out. The control circuit 90 reads out the signals of the pixels 12 connected to the signal lines 161 to the signal line 161 in a row-sequential manner via the vertical scanning circuit 20.

At the subsequent time t0, the control circuit 90 controls the control signals VLRES2 and VLSHT from low-level to high-level to turn off the transistor M52 and turn on the switch S1. Thus, the signal line 161 and the signal line 162 are short-circuited via the switch S1 in a state where the signal lines 161 and 162 are disconnected from the power supply voltage.

At the subsequent time t10, the control circuit 90 controls the control signals VLRES1 and VLSHT from high-level to low-level to turn on the transistor M51 and turn off the switch S1. Thus, the signal line 161 is disconnected from the signal line 162, and the voltage of the signal line 161 is fixed to the power supply voltage.

In a subsequent period from time t10 to time t20, the multiplexer 116 selects the signal line 162 and may output the signals of the pixels 12 connected to the signal line 162 to the comparison circuit 52. Thus, the pixel signals output to the signal line 162 may be read out. The control circuit 90 reads out the signals of the pixels 12 connected to the signal lines 162 to the signal lines 162 in a row-sequential manner via the vertical scanning circuit 20.

At the subsequent time t20, the control circuit 90 controls the control signals VLRES1 and VLSHT from low-level to high-level to turn off the transistor M51 and turn on the switch S1. Thus, the signal line 161 and the signal line 162 are short-circuited via the switch S1 in a state where the signal lines 161 and 162 are disconnected from the power supply voltage.

At the subsequent time t30, the control circuit 90 controls the control signals VLRES2 and VLSHT from high-level to low-level to turn on the transistor M52 and turn off the switch S1. Thus, the signal line 162 is disconnected from the signal line 161, and the voltage of the signal line 162 is fixed to the power supply voltage.

In a subsequent period from time t30 to time t40, the multiplexer 116 selects the signal line 161 and may output the signals of the pixels 12 connected to the signal line 161 to the comparison circuit 52. Thus, the pixel signals output to the signal line 161 may be read out. The control circuit 90 reads out signals of the pixels 12 connected to the signal lines 161 to the signal lines 161 in a row-sequential manner via the vertical scanning circuit 20.

As described above, also in the present embodiment, the signal line in the readout state and the signal line in the reset state are short-circuited at the timing when the signal lines in the readout state and the signal line in the reset state are switched to the power supply voltage. As a result, the speed of the readout operation may be increased as in the case of the first embodiment.

As described above, according to the present embodiment, in a photoelectric conversion device in which a plurality of signal output lines is arranged in each column of a pixel array, it is possible to improve the speed of reading out signals from pixels.

### Fifth Embodiment

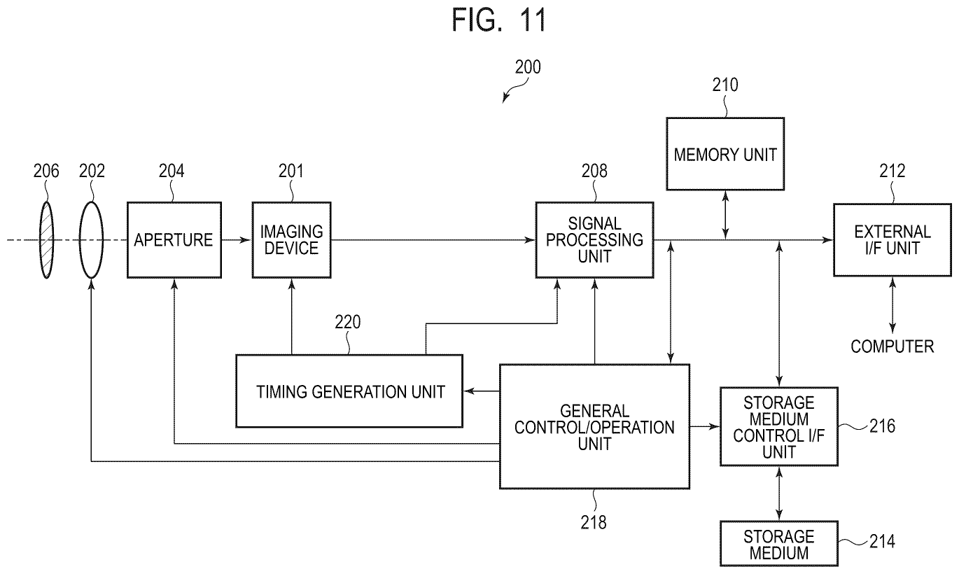

A photoelectric conversion system according to a fifth embodiment of the present invention will be described with reference to FIG. 11. FIG. 11 is a block diagram illustrating a schematic configuration of the photoelectric conversion system according to the present embodiment.

The photoelectric conversion device 100 described in the first to fourth embodiments may be applied to various photoelectric conversion systems. Examples of applicable photoelectric conversion systems include digital still cameras, digital camcorders, surveillance cameras, copying machines, facsimiles, mobile phones, on-vehicle cameras, observation satellites, and the like. A camera module including an optical system such as a lens and an imaging device is also included in the photoelectric conversion system. FIG. 11 exemplifies a block diagram of a digital still camera as one of these.

The photoelectric conversion system 200 illustrated in FIG. 11 includes an imaging device 201, a lens 202 that forms an optical image of an object on the imaging device 201, an aperture 204 that changes the amount of light passing through the lens 202, and a barrier 206 that protects the lens 202. The lens 202 and the aperture 204 form an optical system that focuses light onto the imaging device 201. The imaging device 201 is the photoelectric conversion device 100 described in any of the first to fourth embodiments, and converts the optical image formed by the lens 202 into image data.

The photoelectric conversion system 200 further includes a signal processing unit 208 that processes an output signal output from the imaging device 201. The signal processing unit 208 generates image data from the digital signal output from the imaging device 201. Further, the signal processing unit 208 performs various corrections and compressions as necessary and outputs the processed image data. The imaging device 201 may include an AD conversion unit that generates a digital signal to be processed by the signal processing unit 208. The AD conversion unit may be formed on a semiconductor layer (semiconductor substrate) on which the photoelectric conversion unit of the imaging device 201 is formed or may be formed on a semiconductor layer different from the semiconductor layer on which the photoelectric conversion unit of the imaging device 201 is formed. In addition, the signal processing unit 208 may be formed on the same semiconductor layer as the imaging device 201.

The photoelectric conversion system 200 further includes a memory unit 210 for temporarily storing image data and an external interface unit (external I/F unit) 212 for communicating with an external computer or the like. The photoelectric conversion system 200 further includes a storage medium 214 such as a semiconductor memory for performing storing or reading out of imaging data, and a storage medium control interface unit (storage medium control I/F unit) 216 for performing storing on or reading out from the storage medium 214. The storage medium 214 may be built in the photoelectric conversion system 200 or may be detachable.

The photoelectric conversion system 200 further includes a general control/operation unit 218 that performs various calculations and controls the entire digital still camera, and a timing generation unit 220 that outputs various timing signals to the imaging device 201 and the signal processing unit 208. Here, the timing signal or the like may be input from the outside, and the photoelectric conversion system 200 may include at least the imaging device 201 and the signal processing unit 208 that processes the output signal output from the imaging device 201.

The imaging device 201 outputs an imaging signal to the signal processing unit 208. The signal processing unit 208 performs predetermined signal processing on the imaging signal output from the imaging device 201, and outputs the processed image data. The signal processing unit 208 generates an image using the imaging signal.

As described above, according to the present embodiment, it is possible to realize a photoelectric conversion system to which the photoelectric conversion device 100 according to any of the first to fourth embodiments is applied.

### Sixth Embodiment

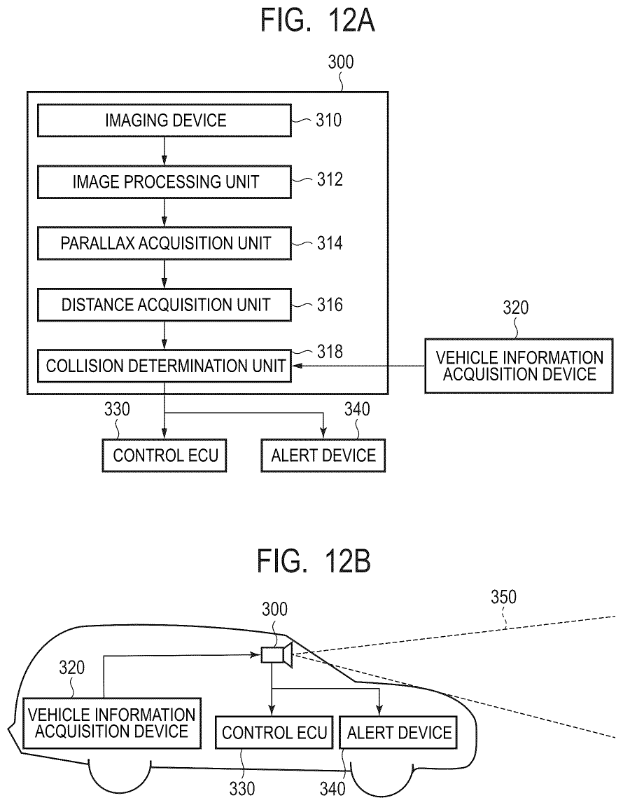

A photoelectric conversion system and a movable object according to a sixth embodiment of the present invention will be described with reference to FIG. 12A and FIG. 12B. FIG. 12A is a diagram illustrating a configuration of a photoelectric conversion system according to the present embodiment. FIG. 12B is a diagram illustrating a configuration of a movable object according to the present embodiment.

FIG. 12A illustrates an example of a photoelectric conversion system related to an on-vehicle camera. The photoelectric conversion system 300 includes an imaging device 310. The imaging device 310 is the photoelectric conversion device 100 according to any one of the first to fourth embodiments. The photoelectric conversion system 300 includes an image processing unit 312 that performs image processing on a plurality of image data acquired by the imaging device 310, and a parallax acquisition unit 314 that calculates parallax (phase difference of parallax images) from the plurality of image data acquired by the imaging device 310. The photoelectric conversion system 300 further includes a distance acquisition unit 316 that calculates a distance to an object based on the calculated parallax, and a collision determination unit 318 that determines whether there is a collision possibility based on the calculated distance. Here, the parallax acquisition unit 314 and the distance acquisition unit 316 are examples of a distance information acquisition unit that acquires distance information to the object. That is, the distance information is information related to a parallax, a defocus amount, a distance to the object, and the like. The collision determination unit 318 may determine the collision possibility using any of the distance information. The distance information acquisition unit may be realized by dedicatedly designed hardware or may be realized by a software module. Further, it may be realized by a field programmable gate array (FPGA), an application specific integrated circuit (ASIC), or the like, or may be realized by a combination of these.

The photoelectric conversion system 300 is connected to the vehicle information acquisition device 320 and may acquire vehicle information such as a vehicle speed, a yaw rate, and a steering angle. Further, the photoelectric conversion system 300 is connected to a control ECU 330 which is a control device that outputs a control signal for generating a braking force to the vehicle based on the determination result of the collision determination unit 318. The photoelectric conversion system 300 is also connected to an alert device 340 that issues an alert to the driver based on the determination result of the collision determination unit 318. For example, when the determination result of the collision determination unit 318 indicates that the possibility of collision is high, the control ECU 330 performs vehicle control to avoid collision and reduce damage by, for example, applying a brake, returning an accelerator, or suppressing engine output. The alert device 340 gives an alert to the user by sounding an alarm such as a sound, displaying alert information on a screen of a car navigation system or the like, giving vibration to a seat belt or a steering wheel, or the like.

In the present embodiment, an image of the surroundings of the vehicle, for example, the front or the rear is captured by the photoelectric conversion system 300. FIG. 12B illustrates the photoelectric conversion system in the case of capturing an image in front of the vehicle (imaging range 350). The vehicle information acquisition device 320 sends instructions to the photoelectric conversion system 300 or the imaging device 310. With such a configuration, the accuracy of distance measurement may be further improved.

Although an example in which control is performed so as not to collide with another vehicle has been described above, the present invention is also applicable to control in which automatic driving is performed so as to follow another vehicle, control in which automatic driving is performed so as not to protrude from a lane, and the like. Further, the photoelectric conversion system is not limited to a vehicle such as an own vehicle, and may be applied to, for example, other movable objects (mobile devices), such as, for example, a ship, an aircraft, or an industrial robot. In addition, the present invention is not limited to the movable object and may be widely applied to equipment using object recognition, such as ITS (Intelligent Transport Systems).

### Seventh Embodiment

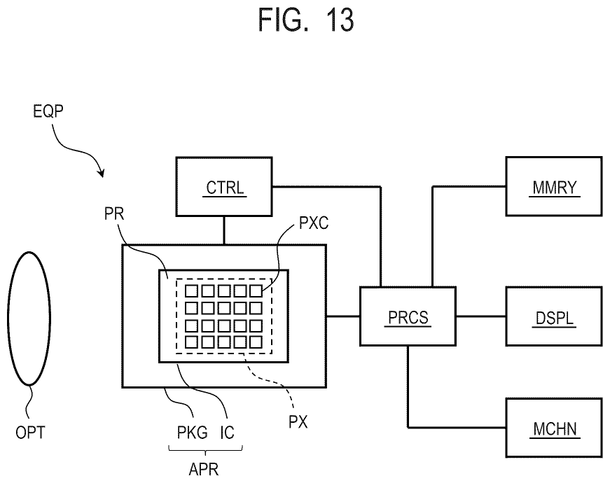

An equipment according to a seventh embodiment of the present invention will be described with reference to FIG. 13. FIG. 13 is a block diagram illustrating a schematic configuration of an equipment according to the present embodiment.

FIG. 13 is a schematic diagram illustrating an equipment EQP including a photoelectric conversion device APR. The photoelectric conversion device APR has the function of the photoelectric conversion device 100 according to any of the first to fourth embodiments. All or part of the photoelectric conversion device APR is a semiconductor device IC. The photoelectric conversion device APR of the present example may be used as, for example, an image sensor, an auto focus (AF) sensor, a photometric sensor, or a distance measurement sensor. The semiconductor device IC includes a pixel region PX in which pixel circuits PXC each including a photoelectric conversion unit are arranged in a matrix. The semiconductor device IC may include a peripheral region PR around the pixel region PX. A circuit other than the pixel circuit may be disposed in the peripheral region PR.

The photoelectric conversion device APR may have a structure (chip stacked structure) in which a first semiconductor chip provided with a plurality of photoelectric conversion units and a second semiconductor chip provided with peripheral circuits are stacked. Each of the peripheral circuits in the second semiconductor chip may be column circuits corresponding to pixel columns of the first semiconductor chip. The peripheral circuits in the second semiconductor chip may be matrix circuits corresponding to pixels or pixel blocks in the first semiconductor chip. As the connection between the first semiconductor chip and the second semiconductor chip, a through electrode (through silicon via (TSV)), an inter-chip interconnection by direct bonding of a conductor such as copper, a connection by a micro bump between chips, a connection by wire bonding, or the like may be employed.

The photoelectric conversion device APR may include a package PKG that accommodates the semiconductor device IC in addition to the semiconductor device IC. The package PKG may include a base body to which the semiconductor device IC is fixed, a lid body such as glass facing the semiconductor device IC, and connection members such as bonding wires or bumps for connecting terminals provided on the base body and terminals provided on the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR as a photoelectric conversion device, and is, for example, a lens, a shutter, or a mirror. The control device CTRL controls the photoelectric conversion device APR, and is, for example, a semiconductor device such as an ASIC. The processing device PRCS processes a signal output from the photoelectric conversion device APR and constitutes an analog front end (AFE) or a digital front end (DFE). The processing unit PRCS is a semiconductor device such as a central processing unit (CPU) or an ASIC. The display device DSPL may be an electroluminescent (EL) display device or a liquid crystal display device that displays information (image) obtained by the photoelectric conversion device APR. The storage device MMRY may be a magnetic device or a semiconductor device that stores information (image) obtained by the photoelectric conversion device APR. The storage device MMRY may be a volatile memory such as an SRAM or a DRAM, or a nonvolatile memory such as a flash memory or a hard disk drive. The mechanical device MCHN may include a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, it is preferable that the equipment EQP further includes a storage device MMRY and a processing device PRCS separately from the storage circuit unit and the arithmetic circuit unit included in the photoelectric conversion device APR.

The equipment EQP illustrated in FIG. 13 may be an electronic device such as an information terminal (for example, a smartphone or a wearable terminal) having a photographing function or a camera (for example, an interchangeable lens camera, a compact camera, a video camera, and a monitoring camera). The mechanical device MCHN in the camera may drive components of the optical device OPT for zooming, focusing, and shutter operation. The equipment EQP may be a transportation device (movable object) such as a vehicle, a ship, or an airplane. The equipment EQP may be a medical device such as an endoscope or a CT scanner.

The mechanical device MCHN in the transport device may be used as a mobile device. The equipment EQP as a transport device is suitable for transporting the photoelectric conversion device APR, or for assisting and/or automating operation (manipulation) by an imaging function. The processing device PRCS for assisting and/or automating driving (manipulation) may perform processing for operating the mechanical device MCHN as a mobile device based on information obtained by the photoelectric conversion device APR.

The photoelectric conversion device APR according to the present embodiment may provide a high value to a designer, a manufacturer, a seller, a purchaser, and/or a user thereof. Therefore, when the photoelectric conversion device APR is mounted on the equipment EQP, the value of the equipment EQP may also be increased. Therefore, in manufacturing and selling the equipment EQP, it is advantageous to determine the mounting of the photoelectric conversion device APR of the present embodiment on the equipment EQP in order to increase the value of the equipment EQP.

### Modified Embodiments

The present invention is not limited to the above-described embodiments, and various modifications are possible.

For example, an example in which a part of the configuration of any of the embodiments is added to another embodiment or an example in which a part of the configurations of any of the embodiments is substituted with some of the configurations of another embodiment is also an embodiment of the present invention.

The circuit configuration of the pixel 12 illustrated in FIG. 2 is an example and may be appropriately changed. For example, each pixel 12 may include two or more photoelectric conversion elements. In this case, a plurality of photoelectric conversion elements may share one FD node. Alternatively, a pupil division pixel in which a plurality of photoelectric conversion elements shares one microlens may be used so that a phase difference may be detected. In addition, the pixel 12 does not necessarily have to include the select transistor M4. The capacitance value of the node FD may be switchable.

The column circuit 42 is not limited to the configuration illustrated in FIG. 3 and may be modified as appropriate. For example, the comparison circuit 52 may further include capacitors and switches for auto-zero operation.

Further, in the above-described embodiments, the example in which the slope-type AD conversion circuit is used for the AD conversion of the pixel signal has been described, but the AD conversion circuit used for the AD conversion of the pixel signal is not limited to the slope-type AD conversion circuit. In addition to the slope-type AD conversion circuit, for example, a successive approximation register (SAR)-type AD conversion circuit, a delta-sigma-type AD conversion circuit, a pipeline-type AD conversion circuit, or the like may be applied to the AD conversion of the pixel signal.

The photoelectric conversion systems described in the fifth and sixth embodiments are examples of photoelectric conversion systems to which the photoelectric conversion device according to the present invention may be applied, and the photoelectric conversion system to which the photoelectric conversion device according to the present invention may be applied is not limited to the configurations illustrated in FIG. 11 and FIG. 12A.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-071604, filed Apr. 25, 2024, which is hereby incorporated by reference herein in its entirety.

What is claimed is:

1. A photoelectric conversion device comprising:
a plurality of pixels including a first pixel group and a second pixel group and arranged to form a column;
a plurality of signal lines including a first signal line connected to the first pixel group and a second signal line connected to the second pixel group; and
a column circuit connected to the plurality of signal lines and including a voltage control unit configured to control supply of a predetermined voltage to each of the plurality of signal lines and a switch circuit configured to control electrical connection and separation between the plurality of signal lines,
wherein the voltage control unit is configured to supply the predetermined voltage to the second signal line in a first period in which a signal from the first pixel group is output to the first signal line and a signal from the second pixel group is not output to the second signal line and supply the predetermined voltage to the first signal line in a second period in which a signal from the second pixel group is output to the second signal line and a signal from the first pixel group is not output to the first signal line, and
wherein the switch circuit is configured to disconnect between the first signal line and the second signal line in the first period and the second period and connect the first signal line and the second signal line in a third period between the first period and the second period.

2. The photoelectric conversion device according to claim 1, wherein a processing of the first period and a processing of the second period are alternately switched.

3. The photoelectric conversion device according to claim 1, wherein the voltage control unit includes a plurality of switches provided between a node to which a fixed voltage is supplied and each of the plurality of signal lines.

4. The photoelectric conversion device according to claim 3, wherein the fixed voltage is a power supply voltage.

5. The photoelectric conversion device according to claim 3, wherein each of the plurality of switches is a p-channel transistor.

6. The photoelectric conversion device according to claim 5,
wherein each of the plurality of pixels includes an n-channel transistor,
wherein the n-channel transistor is provided on a first substrate, and
wherein the p-channel transistor is provided on a second substrate stacked on the first substrate.

7. The photoelectric conversion device according to claim 1, wherein the column circuit includes a first signal processing circuit configured to process a signal output from the first signal line, and a second signal processing circuit configured to process a signal output from the second signal output line.

8. The photoelectric conversion device according to claim 7, wherein the second processing circuit is set to a power saving state in the first period, and the first processing circuit is set to a power saving stage in the second period.

9. The photoelectric conversion device according to claim 1, wherein the column circuit includes a selection circuit configured to select and output one of a signal output from the first signal line and a signal output from the second signal line, and a signal processing circuit configured to process the signal output from the selection circuit.

10. The photoelectric conversion device according to claim 7, wherein the first signal processing circuit and the second signal processing circuit include an analog-to-digital conversion circuit configured to convert analog signals output to the plurality of output lines into digital signals.

11. The photoelectric conversion device according to claim 1,
wherein the plurality of output lines includes three or more signal lines, and
wherein the switch circuit includes a plurality of switches each connected between any two of the plurality of signal lines, and the number of switches connected to each of the plurality of signal lines is the same.

12. The photoelectric conversion device according to claim 1,
wherein the plurality of pixels further includes a third pixel group and a fourth pixel group,
wherein the plurality of signal lines further includes a third signal line connected to the third pixel group and a fourth signal line connected to the fourth pixel group,
wherein the voltage control unit is configured to supply the predetermined voltage to the fourth signal line in the first period in which a signal from the third pixel group is output to the third signal line and a signal from the fourth pixel group is not output to the fourth signal line and supply the predetermined voltage to the third signal line in the second period in which a signal from the fourth pixel group is output to the fourth signal line and a signal from the third pixel group is not output to the third signal line, and
wherein the switch circuit is configured to disconnect between the third signal line and the fourth signal line in the first period and the second period and connect the third signal line and the fourth signal line in the third period.

13. The photoelectric conversion device according to claim 12,
wherein the first pixel group and the second pixel group have a sensitivity to light of a first color,
wherein the third pixel group and the fourth pixel group have a sensitivity to light of a second color different from the first color, and
wherein the switch circuit is configured to connect the first signal line and the second signal line, and the third signal line and the fourth signal line independently each other in the third period.

14. The photoelectric conversion device according to claim 12,
wherein the first pixel group, the second pixel group, the third pixel group, and the fourth pixel group have a sensitivity to light of the same color, and
wherein the switch circuit is configured to connect the first signal line, the second signal line, the third signal line, and the fourth signal line in the third period.

15. A photoelectric conversion device comprising:
a plurality of pixels including a first pixel group and a second pixel group and arranged to form a column;
a plurality of signal lines including a first signal line connected to the first pixel group and a second signal line connected to the second pixel group;
a column circuit connected to the plurality of signal lines and including a voltage control unit configured to control supply of a predetermined voltage to each of the plurality of signal lines and a switch circuit configured to control electrical connection and separation between the plurality of signal lines; and
a control circuit configured to control the column circuit,
wherein the control circuit is configured to
disconnect between the first signal line and the second signal line by the switch circuit and supply the predetermined voltage to the second signal line when a first period in which a signal from the first pixel group is output to the first signa line and a signal from the second pixel group is not output to the second signal line is performed,
disconnect between the first signal line and the second signal line by the switch circuit and supply the predetermined voltage to the first signal line when a second period in which a signal from the second pixel group is output to the second signa line and a signal from the first pixel group is not output to the first signal line is performed, and
connect the first signal line and the second signal line by the switch circuit in a third period between the first period and the second period.

16. The photoelectric conversion device according to claim 15, wherein the control circuit is configured to disconnect between the first signal line and the second signal line by the switch circuit and stop supply of the predetermined voltage to the first signal line and the second signal line by the voltage control unit when an operation of outputting a signal of the first pixel group to the first signal line and an operation of outputting a signal of the second pixel group to the second signal line are performed in parallel.

17. A photoelectric conversion system comprising:
the photoelectric conversion device according to claim 1; and
a signal processing device configured to process a signal output from the photoelectric conversion device.

18. A movable object comprising:
the photoelectric conversion device according to claim 1;
a distance information acquisition unit configured to acquire distance information to an object from a parallax image based on a signal from the photoelectric conversion device; and
a control unit configured to control the movable object based on the distance information.

19. An equipment comprising:
the photoelectric conversion device according to claim 1; and
at least one of
an optical device corresponding to the photoelectric conversion device,
a control device configured to control the photoelectric conversion device,
a processing device configured to process a signal output from the photoelectric conversion device,
a mechanical device that is controlled based on information obtained by the photoelectric conversion device,
a display device configured to display information obtained by the photoelectric conversion device, and
a storage device configured to store information obtained by the photoelectric conversion device.

20. A method of driving a photoelectric conversion device including a plurality of pixels including a first pixel group and a second pixel group and arranged to form a column, a first signal line connected to the first pixel group, and a second signal line connected to the second pixel group, the method comprising:
electrically separating the first signal line and the second signal line and supplying a predetermined voltage to the second signal line in a first period in which a signal from the first pixel group is output to the first signal line and a signal from the second pixel group is not output to the second signal line;
electrically separating the first signal line and the second signal line and supplying a predetermined voltage to the first signal line in a second period in which a signal from the second pixel group is output to the second signal line and a signal from the first pixel group is not output to the first signal line; and
electrically connecting the first signal line and the second signal line in a third period between the first period and the second period.
